(19) United States
(12) Patent Application Publication
(10) Pub. No.: US 2015/0307025 A1
(43) Pub. Date: Oct. 29, 2015

(54) Identifying and Responding to Tailgating Vehicles

(71) Applicant: SAVTi, Arlington, VA (US)

(72) Inventor: Gerald Edmeston Hedley, Arlington, VA (US)

(21) Appl. No.: 14/690,808

(22) Filed: Apr. 20, 2015

Related U.S. Application Data
(60) Provisional application No. 61/984,004, filed on Apr. 24, 2014.

(51) Int. Cl. B60Q 9/00; G06T 7/00; G06K 9/00; G06K 9/32; B60Q 1/30; B60Q 5/00

(52) U.S. Cl. CPC B60Q 9/008; B60Q 1/30; B60Q 5/006; G06K 9/00791; G06K 9/3258; G06T 7/0044; G06T 2207/30252

(57) ABSTRACT

A computer-implemented method includes capturing, using a rear view camera of a forward vehicle, an image of a following vehicle. Based on one or more attributes of the image, a distance between the forward vehicle and the following vehicle is determined. Based on the distance between the forward vehicle and the following vehicle and on a speed of the forward vehicle, it is determined that the following vehicle is closer than a predetermined distance. In response to determining that the following vehicle is closer than the predetermined distance, a first safety response is activated.

### FIELD

The present application relates to vehicle safety.

### BACKGROUND

Tailgating, following a vehicle too closely, is an unsafe practice that causes rear end collisions. Generally, a vehicle is considered to be tailgating when it is following another vehicle at a distance that does not allow the following vehicle's driver, in response to a hazard or to changing traffic speed, adequate reaction time to slow or to stop. Because many drivers fail to appreciate the dangers of tailgating, other drivers must remain alert and must practice defensive driving techniques in order to avoid potential collisions.

However, because safe driving requires careful attention and continuous scanning for hazards in all directions, even responsible drivers are sometimes unable to identify a vehicle that is following too closely and to take appropriate action in time to prevent a collision.

### SUMMARY

Vehicle safety technology can assist drivers in identifying and responding to tailgating vehicles. For example, vehicle safety technology can automatically determine that a following vehicle is tailgating and activate a safety response.

In one aspect, an image of a following vehicle is captured using a rear view camera of a forward vehicle. Based on one or more attributes of the image, a distance between the forward vehicle and the following vehicle is determined. Based on the distance between the forward vehicle and the following vehicle and on a speed of the forward vehicle, it is determined that the following vehicle is closer than a predetermined distance. In response to determining that the following vehicle is closer than the predetermined distance, a first safety response is activated.

In another aspect, the distance between the forward vehicle and the following vehicle is determined through stadiametric range estimation. The distance can be determined, for example, based on an estimated size of the following vehicle and on a position of the following vehicle within the image. In another example, the distance can be determined based on an estimated size of the following vehicle and on a size of the following vehicle within the image.

In another aspect, activating the first safety response can include one or more of flashing brake lights of the forward vehicle, flashing hazard lights of the forward vehicle, activating a horn of the forward vehicle, and/or providing an alert to the driver of the forward vehicle. As part of the first safety response, brake lights and/or hazard lights of the forward vehicle can flash a preset number of times.

In yet another aspect, after a preset length of time, a determination can be made that the following vehicle remains closer than the predetermined distance. A second image of a following vehicle, for example, is captured using a rear view camera of a forward vehicle. Based on one or more attributes of the image, a distance between the forward vehicle and the following vehicle is determined. Based on the distance between the forward vehicle and the following vehicle and on a speed of the forward vehicle, it is determined that the following vehicle is closer than a predetermined distance. In response to determining that the following vehicle is closer than a predetermined distance, a second safety response is activated.

In another aspect, activating the second safety response can include one or more of flashing brake lights of the forward vehicle, flashing hazard lights of the forward vehicle, activating a horn of the forward vehicle, and/or providing an alert to the driver of the forward vehicle. As part of the second safety response, brake lights and/or hazard lights of the forward vehicle can flash a preset number of times.

In yet another aspect, a license plate number of the following vehicle is determined based on the image of the following vehicle, and the following vehicle's license plate number is stored.

Other implementations of these aspects include corresponding systems, apparatus, and computer programs, configured to perform the described techniques, encoded on computer storage devices.

The details of one or more implementations of the subject matter described in this specification are set forth in the accompanying drawings and the description below. Other potential features, aspects, and advantages of the subject matter will become apparent from the description, the drawings, and the claims.

### DESCRIPTION OF FIGURES

FIG. 1 is a diagram of an example system that identifies and responds to a tailgating vehicle.

FIGS. 2A and 2B illustrate an example of identifying a tailgating vehicle.

FIG. 3 is a flowchart of an example of a process for identifying and responding to a tailgating vehicle.

FIG. 4 is a flowchart of an example of a process for identifying and responding to a tailgating vehicle.

### DETAILED DESCRIPTION

Traditional approaches to identifying tailgating rely entirely on the careful attention of the drivers involved. A conscientious driver of a following vehicle might, for example, guess at and attempt to maintain a safe distance, taking into account speed and road conditions. Similarly, a driver of a forward vehicle can guess at whether a particular following vehicle is dangerously close by monitoring the forward vehicle's rear view mirror. But many drivers fail to take these precautions and, even if the driver of a forward vehicle recognizes that a following vehicle is tailgating, options available to the forward vehicle's driver to alert the following vehicle's driver to danger are limited, and can even pose dangers of their own. Pumping the breaks of a forward vehicle, for example, might catch the attention of a tailgating driver, but it can also close the gap between the forward and following vehicles even further.

The vehicle safety technology described herein solves these and other problems, assisting drivers in avoiding collisions by automatically determining when a following vehicle is tailgating and, when appropriate, activating one or more safety responses. Images produced by a forward vehicle's rear view camera, for example, can be continuously processed to accurately determine distances between forward and following vehicles at various points in time. Combined with information regarding vehicle speed, these distance calculations provide the means for objectively determining that a following vehicle is tailgating. When such a determination is made, various safety systems can be employed to alert the drivers involved, through one or more automatically triggered responses directed at either or both of the drivers. Patterned flashing of a forward vehicle's brake lights can be combined, for example, with an audio queue for driver of the forward vehicle, with other responses being possible depending on circumstances.

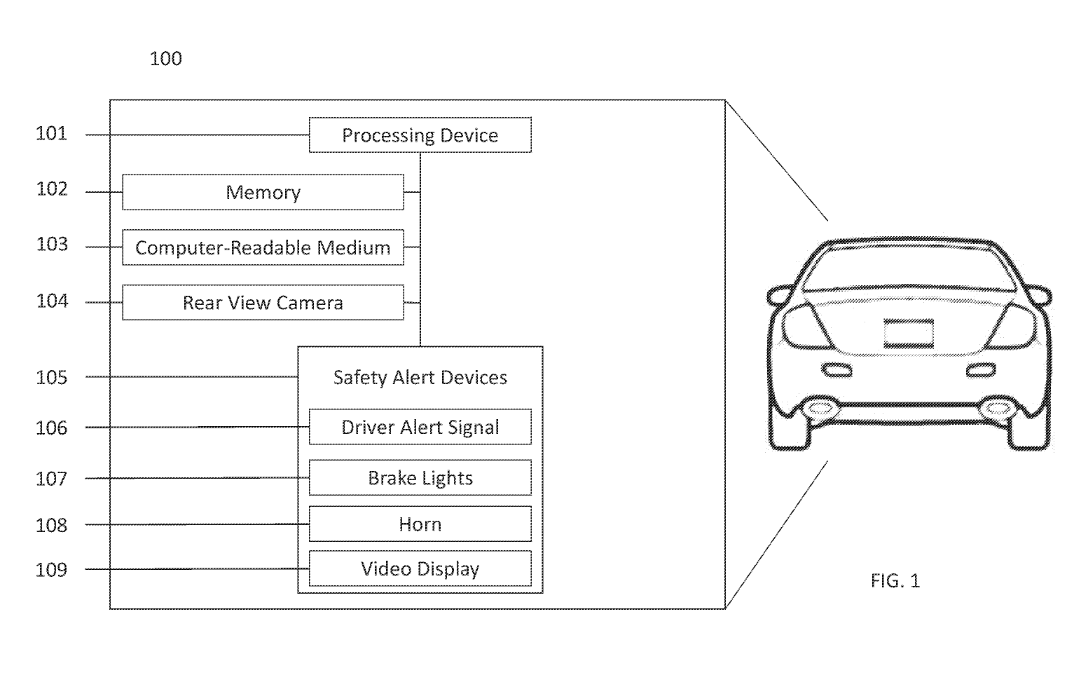

FIG. 1 is a diagram of an example system 100 that identifies and responds to a tailgating vehicle. The system 100 includes a processing device 101 that is interconnected with memory 102, computer-readable medium 103, rear view camera 104, and a collection of safety devices 105. Processing device 101 is, for example, a vehicular computer system, electronic control unit, or any other appropriate computing device.

Generally speaking, processing device 101 is a device that offers advanced computing capabilities, such as the ability to execute applications and to communicate with other computing devices (for example, an engine control unit (ECU)), with rear view camera 104, and with safety devices that include driver alert signal 106, brake lights 107, horn 108, and video display 109. Computer-readable medium 103 stores data and computer programs that are accessible to processing device 101. Memory 102 (for example, RAM) is used by processing device 101 to execute computer programs.

Rear view camera 104 is a video camera designed to be attached to the rear of a vehicle, with a lens facing behind the vehicle. When rear view camera 104 is connected to a video display 109, the image that it produces can be displayed to the vehicle's driver. Images produced by rear view camera 104 alleviate the vehicular rear blind spot, and thereby assist the driver with backing up and with avoiding backup collisions. The combination of processing device 101 with rear view camera 104 provides additional functionality, including the ability to identify tailgating vehicles through image processing techniques that include, for example, stadiametric range estimation.

In an exemplary configuration, rear view camera 104 captures an image of a following vehicle and, based on one or more attributes of the image, processing device 101 determines a distance between the following vehicle and the forward vehicle (the vehicle in which processing device 101 is installed). Processing device 101 can determine the distance, for example, based on an estimated size of the following vehicle (for example, an average width of a car) and on a position of the following vehicle within the image. Processing device 101 can also determine the distance based on an estimated size of the following vehicle and on a size of the following vehicle within the image (for example, a width measured by pixel count).

Based on the distance between the forward vehicle and the following vehicle and on a speed of the forward vehicle, processing device 101 determines that the following vehicle is closer than a predetermined distance and is, therefore, tailgating. When a tailgating vehicle is identified, processing device 101 involves one ore more of the devices included in the collection of safety devices 105 (for example, driver alert signal 106, brake lights 107, horn 108, video display 109, and/or other devices) in one or more safety responses.

Safety responses can be directed toward either or both of the driver of the following vehicle and the driver of the forward vehicle. Safety responses are designed to indicate that a vehicle is following at a distance that would not allow the following vehicle's driver adequate reaction time to slow or to stop in response to a hazard or to changing traffic speed. A safety response includes, for example, flashing brake and/or hazard lights 107, activating horn 108, and/or providing an alert to the driver of the forward vehicle using driver alert signal 106 and/or video display 109.

Depending on circumstances, processing device 101 may activate a sequence of varied safety responses. A sequence of safety responses are activated, for example, if processor 101 determines that the following vehicle is closer than a predetermined distance and then determines, after activating a first safety response, that the following vehicle remains closer than the predetermined distance. An example sequence could include flashing brake lights a preset number of times, followed by flashing hazard lights a preset number of times, and then providing an alert to the driver of the forward vehicle. Other sequences are possible. Processing device 101 can also, based on the image of the following vehicle, determine and then store a license plate number of the following vehicle.

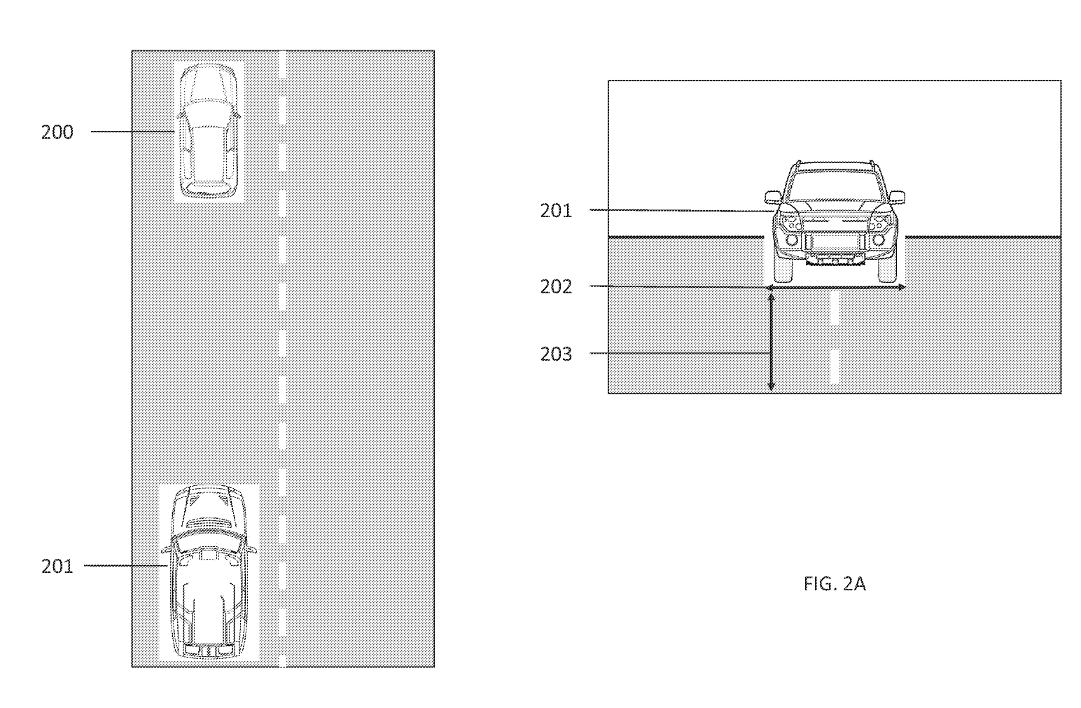

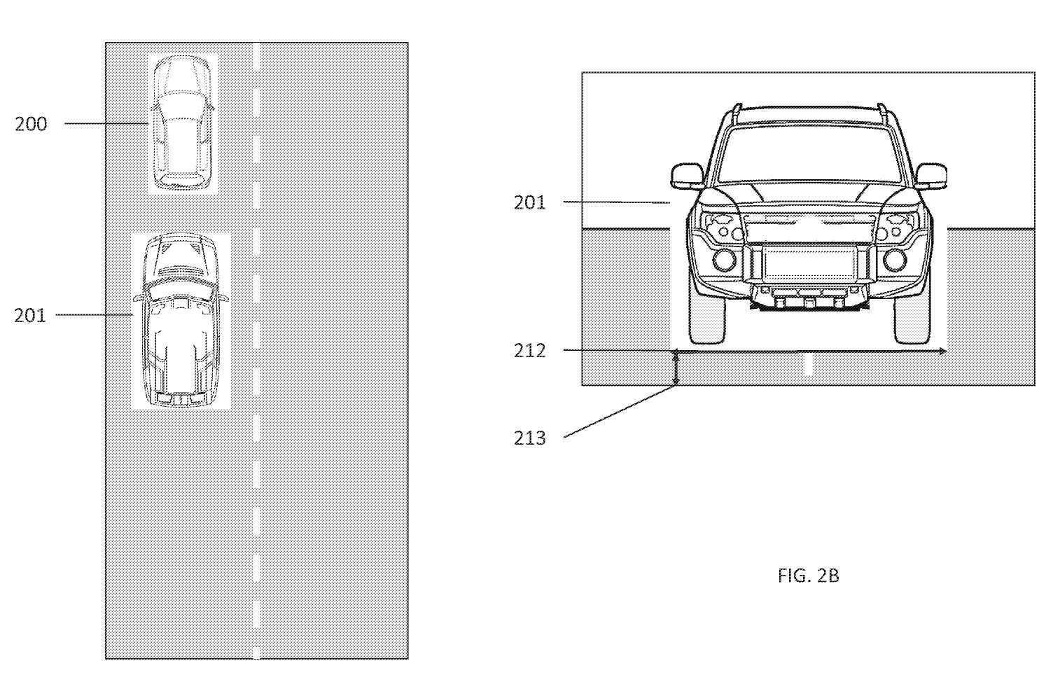

FIGS. 2A and 2B illustrate an example of identifying a tailgating vehicle. FIG. 2A and FIG. 2B each depict a forward vehicle 200 and a following vehicle 201. FIG. 2A depicts the two vehicles at a first point in time, and FIG. 2B depicts the two vehicles at a second point in time. In the illustrated example, the forward vehicle 200 is equipped with system 100, including processing device 101 and rear view camera 104.

FIG. 2A includes an illustration of following vehicle 201 driving on a road several car lengths behind forward vehicle 200. Rear view camera 104, which is attached to the rear of forward vehicle 200, with its lens facing toward following vehicle 201, captures an image of following vehicle 201. In FIG. 2A, the captured image of following vehicle 201 is illustrated with lines indicating a vehicle width 202 and a vehicle distance 203.

Based on one or more attributes of the image, processing device 101 determines the vehicle distance 203 between the following vehicle 201 and the forward vehicle 200. Processing device 101 can determine the distance, for example, through stadiametric range estimation. Stadiametric range estimation is generally used to determine the size of an object at a known distance or, as in the present example, a distance to an object of a known size, based on the principle that, for a right triangle with a given angle, the ratio of adjacent side length to opposite side length is constant.

In this example, the vehicle width 202 is an average width of a vehicle, rather than an actual width of vehicle 201. Using this average width as the “known size” for purposes of stadiametric range estimation, in addition to an angular measurement, processing device 101 derives an estimate of vehicle distance 203.

Using this derived estimate of vehicle distance 203, in addition to a measure of forward vehicle 200's speed, processing device 101 determines whether following vehicle 201 is within a predetermined distance that indicates that following vehicle 201 is tailgating.

The predetermined distance may vary, for example, with forward vehicle 200's speed, with faster speeds requiring a larger distance for safe driving. A vehicle driving at 55 miles per hour, for example, travels 81 feet per second. At this speed, a predetermined distance providing the driver of the following vehicle 201 3 seconds to respond to a full stop by forward vehicle 200 would be 243 feet. At a speed of 65 miles per hour, a predetermined distance allowing for 3 seconds of reaction time would instead be 288 feet.

At the point in time depicted by FIG. 2A, processing device 101 may determine that following vehicle 201 is not tailgating forward vehicle 200. FIG. 2B, however, depicts following vehicle 201 driving, at a second point in time, less than one full car length behind forward vehicle 200. Using the average vehicle width 212 as the “known size” for purposes of stadiametric range estimation, in addition to an angular measurement, processing device 101 derives an estimate of vehicle distance 213.

Using this derived estimate of vehicle distance 213, in addition to a measure of forward vehicle 200′s speed, processing device 101 determines whether following vehicle 201 is within a predetermined distance that indicates that following vehicle 201 is tailgating. At the second point in time depicted by FIG. 2B, processing device 101 may determine that following vehicle 201 is tailgating forward vehicle 200.

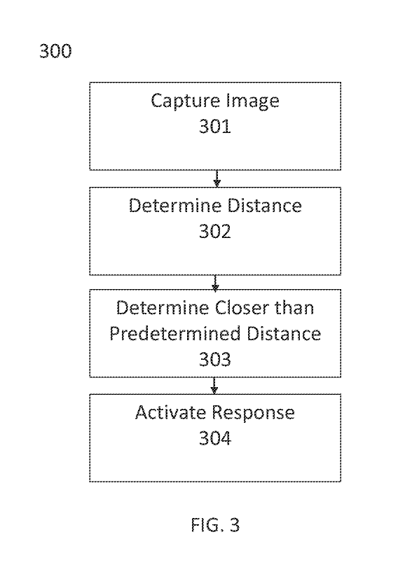

FIG. 3 is a flowchart of an example of a process for identifying and responding to a tailgating vehicle. The process is implemented, for example, using system 100. In such an implementation, one or more parts of the process is executed by processing device 101, which retrieves information involved in the process from one or more local or remote data sources, such as memory 102, computer-readable medium 103, and rear view camera 104. Processing device 101 is further interconnected with one or more of a collection of safety alert devices 105, which can include driver alert signal 106, brake and/or hazard lights 107, horn 108, and/or video display 109.

Referring to FIG. 3, rear view camera 104 of a forward vehicle captures an image of a following vehicle (301). Based on one or more attributes of the image, processing device 101 determines a distance between the forward vehicle and the following vehicle (302). Processing device 101 can determine the distance between the forward vehicle and the following vehicle through stadiametric range estimation. Processing device 101 can determine the distance, for example, based on an estimated size of the following vehicle and on a position of the following vehicle within the image. Processing device 101 can also determine the distance based on an estimated size of the following vehicle and on a size of the following vehicle within the image.

Based on the distance between the forward vehicle and the following vehicle and on a speed of the forward vehicle, processing device 101 determines that the following vehicle is closer than a predetermined distance (303). In response to determining that the following vehicle is closer than the predetermined distance, processing device 101 activates a first safety response (304).

The activated first safety response includes, for example, flashing brake and/or hazard lights 107, activating horn 108, and/or providing an alert to the driver of the forward vehicle using driver alert signal 106 and/or video display 109.

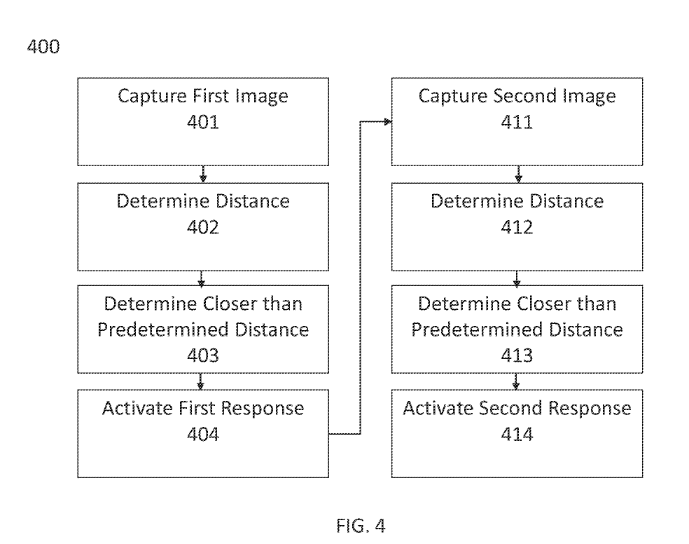

FIG. 4 is a flowchart of an example of a process for identifying and responding to a tailgating vehicle. The process is implemented, for example, using system 100. In such an implementation, one or more parts of the process is executed by processing device 101, which retrieves information involved in the process from one or more local or remote data sources, such as memory 102, computer-readable medium 103, and rear view camera 104. Processing device 101 is further interconnected with one or more of a collection of safety alert devices 105, which can include driver alert signal 106, brake lights 107, horn 108, and/or video display 109.

Referring to FIG. 4, rear view camera 104 of a forward vehicle captures an image of a following vehicle (401). Based on one or more attributes of the image, processing device 101 determines a distance between the forward vehicle and the following vehicle (402). Processing device 101 can determine the distance between the forward vehicle and the following vehicle through stadiametric range estimation. Processing device 101 can determine the distance, for example, based on an estimated size of the following vehicle and on a position of the following vehicle within the image. Processing device 101 can also determine the distance based on an estimated size of the following vehicle and on a size of the following vehicle within the image.

Based on the distance between the forward vehicle and the following vehicle and on a speed of the forward vehicle, processing device 101 determines that the following vehicle is closer than a predetermined distance (403). In response to determining that the following vehicle is closer than the predetermined distance, processing device 101 activates a first safety response (404).

The activated first safety response includes, for example, flashing brake and/or hazard lights 107, activating horn 108, and/or providing an alert to the driver of the forward vehicle using driver alert signal 106 and/or video display 109.

Rear view camera 104 of the forward vehicle then captures a second image of a following vehicle (411). The second image is captured, for example, after a preset length of time, for example, ______, from the capture of the first image. Based on one or more attributes of the second image, processing device 101 determines a distance between the forward vehicle and the following vehicle, which may be the same as, or different from, the earlier determined distance between the forward vehicle and the following vehicle (412).

Based on the distance between the forward vehicle and the following vehicle and on a speed of the forward vehicle, processing device 101 may determine that the following vehicle remains closer than a predetermined distance (413). In response to determining that the following vehicle is closer than a predetermined distance, a second safety response is activated (414).

The activated second safety response includes, for example, flashing brake and/or hazard lights 107, activating horn 108, and/or providing an alert to the driver of the forward vehicle using driver alert signal 106 and/or video display 109. Processing device 101 can also, based on the image of the following vehicle, determine and then store a license plate number of the following vehicle.

What is claimed is:

1. A method comprising:
capturing, using a rear view camera of a forward vehicle, an image of a following vehicle;
determining, based on one or more attributes of the image, a distance between the forward vehicle and the following vehicle;
determining, based on the distance between the forward vehicle and the following vehicle and on a speed of the forward vehicle, that the following vehicle is closer than a predetermined distance; and
in response to determining that the following vehicle is closer than the predetermined distance, activating a first safety response.

2. The method of claim 1, wherein the distance between the forward vehicle and the following vehicle is determined based on an estimated size of the following vehicle and on a position of the following vehicle within the image.

3. The method of claim 1, wherein the distance between the forward vehicle and the following vehicle is determined based on an estimated size of the following vehicle and on a size of the following vehicle within the image.

4. The method of claim 1, wherein the distance between the forward vehicle and the following vehicle is determined through stadiametric range estimation.

5. The method of claim 1, wherein activating the first safety response comprises flashing brake lights of the forward vehicle.

6. The method of claim 5, wherein, as part of the first safety response, brake lights of the forward vehicle flash a preset number of times.

7. The method of claim 1, wherein activating the first safety response comprises providing an alert to the driver of the forward vehicle.

8. The method of claim 1, wherein the first safety response is selected from a group consisting of flashing brake lights of the forward vehicle, flashing hazard lights of the forward vehicle, activating a horn of the forward vehicle, and providing an alert to the driver of the forward vehicle.

9. The method of claim 1, further comprising:
determining, after a preset length of time, that the following vehicle remains closer than the predetermined distance; and
in response to determining that the following vehicle remains closer than the predetermined distance, activating a second safety response.

10. The method of claim 1, further comprising:
capturing, using the rear view camera of the forward vehicle, a second image of the following vehicle;
determining, based on one or more attributes of the second image, a distance between the forward vehicle and the following vehicle;
determining, based on the distance between the forward vehicle and the following vehicle and on a speed of the forward vehicle, that the following vehicle is closer than a predetermined distance; and
in response to determining that the following vehicle is closer than a predetermined distance, activating a second safety response.

11. The method of claim 10, wherein activating the second safety response comprises flashing hazard lights of the forward vehicle.

12. The method of claim 1, further comprising:
determining, based on the image of the following vehicle, a license plate number of the following vehicle; and
storing the determined license plate number.

13. A system comprising:
one or more processing devices; and
one or more non-transitory computer-readable media coupled to the one or more processing devices having instructions stored thereon which, when executed by the one or more processing devices, cause the one or more processing devices to perform operations comprising:
capturing, using a rear view camera of a forward vehicle, an image of a following vehicle;
determining, based on one or more attributes of the image, a distance between the forward vehicle and the following vehicle;
determining, based on the distance between the forward vehicle and the following vehicle and on a speed of the forward vehicle, that the following vehicle is closer than a predetermined distance; and
in response to determining that the following vehicle is closer than the predetermined distance, activating a first safety response.

14. The system of claim 13, wherein the distance between the forward vehicle and the following vehicle is determined based on an estimated size of the following vehicle and on a position of the following vehicle within the image.

15. The system of claim 13, wherein the distance between the forward vehicle and the following vehicle is determined based on an estimated size of the following vehicle and on a size of the following vehicle within the image.

16. The system of claim 13, wherein the distance between the forward vehicle and the following vehicle is determined through stadiametric range estimation.

17. The system of claim 13, wherein the first safety response is selected from a group consisting of flashing brake lights of the forward vehicle, flashing hazard lights of the forward vehicle, activating a horn of the forward vehicle, and providing an alert to the driver of the forward vehicle.

18. The system of claim 13, further comprising:
determining, after a preset length of time, that the following vehicle remains closer than the predetermined distance; and
in response to determining that the following vehicle remains closer than the predetermined distance, activating a second safety response.

19. The system of claim 13, further comprising:
capturing, using the rear view camera of the forward vehicle, a second image of the following vehicle;
determining, based on one or more attributes of the second image, a distance between the forward vehicle and the following vehicle;
determining, based on the distance between the forward vehicle and the following vehicle and on a speed of the forward vehicle, that the following vehicle is closer than a predetermined distance; and
in response to determining that the following vehicle is closer than a predetermined distance, activating a second safety response.

20. A non-transitory computer-readable storage device encoded with a computer program, the program comprising instructions that when executed by a data processing apparatus cause the data processing apparatus to perform operations comprising:
capturing, using a rear view camera of a forward vehicle, an image of a following vehicle;
determining, based on one or more attributes of the image, a distance between the forward vehicle and the following vehicle;
determining, based on the distance between the forward vehicle and the following vehicle and on a speed of the forward vehicle, that the following vehicle is closer than a predetermined distance; and
in response to determining that the following vehicle is closer than the predetermined distance, activating a first safety response.
